(19) United States
(12) Patent Application Publication
(10) Pub. No.: US 2013/0152729 A1
(43) Pub. Date: Jun. 20, 2013

(54) TORSION DAMPER

(71) Applicant: Schaeffler Technologies GmbH & Co. KG, Herzogenaurach (DE)

(72) Inventor: Stephan Maienschein, Baden-Baden (DE)

(73) Assignee: SCHAEFFLER TECHNOLOGIES GMBH & CO. KG, Herzogenaurach (DE)

(21) Appl. No.: 13/706,965

(22) Filed: Dec. 6, 2012

(30) Foreign Application Priority Data
Dec. 16, 2011 (DE) 102011088801.2

(51) Int. Cl. F16F 15/14

(52) U.S. Cl. CPC F16F 15/1407
USPC 74/572.21

(57) ABSTRACT

A torsional damper having an input side for introducing a torque, an output side for outputting the torque, an energy storage element arranged between the input side and the output side on a circumference about an axis of rotation to elastically transmit the torque between the input side and the output side, and a retaining element arranged on the radially outer side of the energy storage element to support the energy storage element. An angle of rotation of the retaining element relative to the input side and to the output side about the axis of rotation is not limited.

### CROSS-REFERENCE TO RELATED APPLICATIONS

This patent claims priority of German Patent Application No. 10 2011 088 801.2 filed Dec. 16, 2011, which application is hereby incorporated by reference.

### FIELD OF THE INVENTION

The invention relates to a torsion damper. In particular, the invention relates to a torsion damper including an energy storage element for an elastic transmission of a torque between an input side and an output side. Moreover, the invention relates to a torque converter that includes a torsion damper of this type.

### BACKGROUND OF THE INVENTION

In a drive train, for example between a drive motor and a transmission of a motor vehicle, a torque converter including a torsion damper may be used to transmit a torque in the drive train. The torsion damper generally comprises an arc spring or another energy storage element arranged on a circumference about an axis of rotation. Ends of the arc spring are engaged with an input side and an output side, respectively, of the torsion damper. When the transmitted torque changes, for example as a result of a torque fluctuation or a torsional vibration in the drive train, the arc spring is compressed or decompressed and contributes to isolating the torque fluctuation between the two sides.

The arc spring rotates with the input side and the output side about the axis of rotation and is thus subject to a centrifugal force. Moreover, when the ends of the arc spring are compressed between the input side and the output side, the arc spring is subject to a force acting in a radially outward direction. The arc spring is frequently supported in a radially outward direction by what is known as a retainer, which is formed on or mounted to the input or output side and comprises a support element for engaging and supporting the radially outer side of the arc spring. During a compression or decompression of the arc spring, friction is created between the retainer and sections of the arc spring.

For example, if the retainer is arranged on the output side, during a compression or decompression of the arc spring, the axial arc spring end engaged with the input side will move through a greater distance relative to the retainer than the end engaged with the output side. This results in an uneven distribution of friction and spring forces along the arc spring, which may affect a responding behavior and the useful life of the arc spring.

### BRIEF SUMMARY OF THE INVENTION

An object of the invention is to provide a torsion damper for a torque converter that permits a more even distribution of the load applied to the energy storage element.

In accordance with the invention, a torsion damper comprises an input side for introducing a torque, an output side for outputting the torque, an energy storage element arranged on a circumference about an axis of rotation between the input side and the output side to elastically transmit the torque between the input side and the output side, and a retaining element arranged on the radially outer side of the energy storage element to support the energy storage element. An angle of rotation of the retaining element relative to the input side and the output side about the axis of rotation is not limited.

In particular in terms of its rotary movement, such a free-wheel retaining element may be coupled to the input and output sides only by frictional forces. The frictional forces may be transmitted by the energy storage element. The retaining element is not part of the transmission of torque between the input side and the output side and may contribute to ensuring that windings of the energy storage element at opposing ends are exposed to equal friction and a friction path of equal length relative to the retaining element when the energy storage element is compressed or decompressed. The dynamic properties of the energy storage elements for isolating torsional vibrations, in particular a responding behavior and a border frequency may be positively influenced thereby. In addition, total friction between the energy storage element and the retaining element may be reduced, which extends the useful life of the energy storage element. Furthermore, abrasion between the energy storage element and the retaining element may be minimized, so that abrasion-related wear on other elements in the region of the torsion damper may be reduced. Elements of the torsion damper may be of less sturdy dimensions, potentially reducing manufacturing costs.

In accordance with a preferred embodiment, the retaining element may be designed to support the energy storage element on one or on both axial sides. This is a way for the retaining element to fix the energy storage element both in the radial and in the axial direction so that the actuation of the energy storage element is functionally separate from its attachment. Due to this functional separation, the individual components may be optimized in terms of their allotted purpose.

In accordance with a further feature, the retaining element may comprise a radial portion as a radial support relative to the input side and to the output side to center the retaining element relative to the axis of rotation. Thus, the potential tendency of the energy storage to be out of balance in some operating conditions may be suppressed in an improved way. However, the radial portion is not mandatory; in a further embodiment, there may be no radial portion and the retaining element may rest against the energy storage element radially to the outside in the manner of a revolving tire. Direct contact between the retaining element and the input/output side may thus be avoided so that a rotary position of the retaining element may only indirectly depend on the movements of the input side and of the output side.

If there is a radial portion an axial fixing element may be provided on the input side and/or on the output side to fix the radial portion of the retaining element in the axial direction. An axial frictional force acting between the energy storage element and the retaining element may thus be reduced.

The retaining element is preferably made of a sheet material and may thus resemble and be manufactured like a known retaining element. The retaining element may in particular be made out of a known retaining element that is provided with an additional radial portion.

In accordance with a further preferred embodiment, multiple energy storage elements are provided that act in parallel and are supported by the retaining element. The energy storage elements are preferably arranged on the same circumference about the axis of rotation so that the centrifugal forces applied to the retaining element by the different energy storage elements may at least partially eliminate each other. Forces for supporting the retaining element relative to the input side or to the output side, for example, may thus be minimized.

In accordance with a further preferred embodiment, the input side or the output side comprises a hub that is connected in a torque-locking way to a radial element engaged with an end of the energy storage element. The hub may advantageously be used to radially or axially fix the radial portion of the retaining element. The radial portion of the retaining element may rest against a radial portion of the input or output side, allowing a compact design of the torsion damper.

In accordance with the invention, a torque converter comprises the torsion damper described above and a hydrodynamic transmission device including a fluid for transmitting torque in a direction parallel to the energy storage element. The improved properties of the torsion damper of the invention in terms of the damping of vibrations may thus be advantageously used in a torque converter. The damping of vibration during the transmission of torque is achieved exclusively by means of the hydrodynamic transmission device. As a consequence, the energy storage element of the torsion damper may be specifically designed to absorb torsional vibrations during a driving operation in which the hydrodynamic transmission device is bridged, for instance by a friction clutch. The spring properties of the energy storage element may thus be optimized in terms of the driving operation, which means that improved vibration isolation can be achieved during the driving operation.

The retaining element is preferably exposed to the fluid of the transmission device. This may even further increase the movability of the retaining element relative to the energy storage element, potentially attaining an even better vibration damping effect.

### BRIEF DESCRIPTION OF THE DRAWINGS

The invention will be described in more detail below with reference to the appended drawings.

FIG. 1 is a torque converter including a torsion damper; and,

FIG. 2 is a diagrammatic representation of the torsion damper shown in FIG. 1.

### DETAILED DESCRIPTION OF THE INVENTION

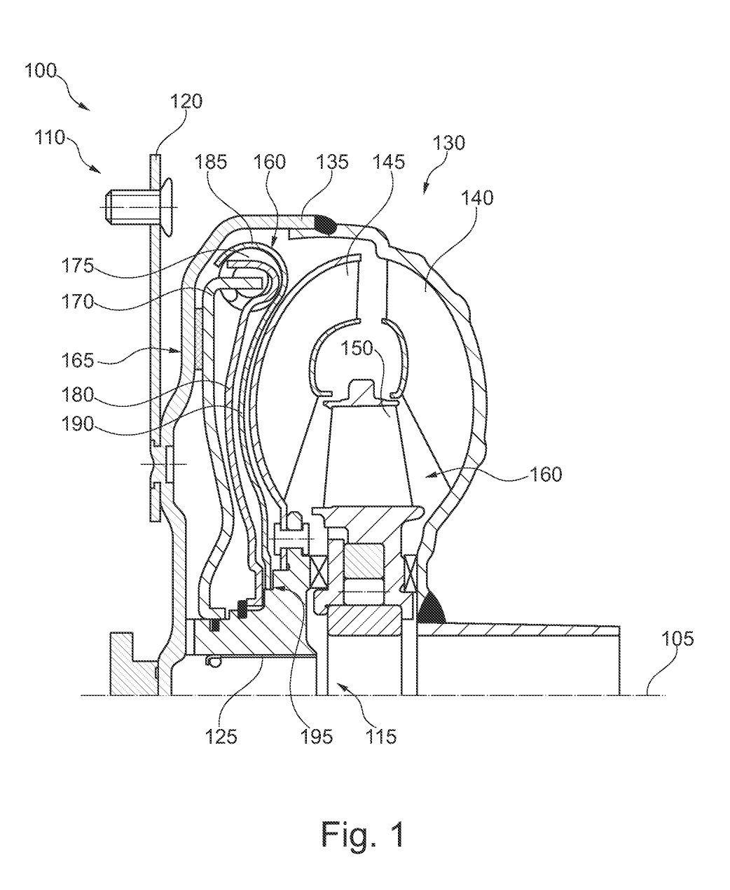

FIG. 1 illustrates a longitudinal section of an upper half of a torque converter 100. The torque converter 100 is arranged to transmit a torque relative to an axis of rotation 105. For this purpose, the torque converter 100 comprises a primary side 110 for connection with a drive motor in a drive train, in particular of a motor vehicle, and a secondary side 115 for connection with a transmission of the motor vehicle. The primary side 110 comprises a flange 120 for introducing the torque. The secondary side 115 is formed by a hub 125, which is preferably toothed or splined to transmit the torque to a shaft.

A hydrodynamic torque converter 130 is arranged between the primary side 110 and the secondary side 115. The torque converter 130 comprises a housing 135 on which an impeller 140 is formed or arranged, a turbine 145 connected to the hub 125, and a stator 150. Inside the housing 135, in particular between impeller 140, turbine 145, and stator 150, a fluid 155, in particular oil, is provided for the fluidic transmission of power between the impeller 140 and the turbine 145. In accordance with one embodiment of the torque converter 100, there are devices for circulating the fluid 155 within the housing 135.

Torque converter 100 further comprises a torsion damper 160 as an alternative path for transmitting power from the primary side 110 to the secondary side 115. To use this path, a friction clutch 165 is provided to create a lock-up connection between the housing 135/flange 120 of the primary side 110 of torque converter 100 to an input side 170 of the torsion damper 160. An energy storage element 175 extends along a circumference about the axis of rotation 105 and is engaged at its axial ends with the input side 170 and an output side 180, respectively, of the torsion damper 160. The energy storage element 175 is shown to be an arc spring; however, it may also be a compression spring or a tension spring. The output side 180 is connected in a torque-locking way to the hub 125, which simultaneously forms the secondary side 115 of torque converter 100.

On its radially outer side, the energy storage element 175 is guided by a retaining element 185. Retaining element 185, also referred to as a retainer, may preferably be manufactured by forming a sheet of material, in particular a flat sheet metal. In the illustrated embodiment, the retaining element 185 also rests against the energy storage element 175 in both axial directions relative to the axis of rotation 105.

An optional radial portion 190 of the retaining element 185 extends towards the axis of rotation 105 up to the hub 125. The radial portion 190 may be bent in the axial direction as shown to use the available installation space in an optimum way. In particular, the radial portion 190 may be adapted to the curvature of the turbine 145. In the illustrated embodiment, the radial portion 190 is located between the turbine 145 and the output side 180; in other embodiments, the radial portion 190 may, for example, be arranged between the input side 170 and the output side 180 or between the housing 135 and the input side 170.

The crucial aspect is that neither on the input side 170 nor on the output side 180 is the retaining element 185 rigidly fixed. Instead, apart from frictional forces, the retaining element 185 is freely rotatable about the axis of rotation 105, independently of the input side 170 and of the output side 180. Forces acting on the energy storage element 175 in a radially outward direction, for example resulting from centrifugal forces during a rotation of the arc spring 175 about the axis of rotation 105 or from shearing forces during a compression of the energy storage element 175 between the input side 170 and the output side 180, are virtually entirely absorbed by the retaining element 185. Consequently, a compression or decompression of the energy storage element 175 is damped as little as possible by friction on the retaining element 185. In particular, due to the free-wheel retaining element 185, relative distances that opposing ends of the energy storage element 175 pass through may be of equal length relative to the retaining element 185 and the forces respectively acting on the energy storage element 175 in the radial direction may correspond to each other.

In the illustrated embodiment, the retaining element 185 is axially and radially attached to a shoulder 195 of the hub 125. In other embodiments, only an axial or only a radial attachment may be provided. The retaining element 185 may axially or radially be attached to another element of the torsion damper 160 or of torque converter 100, in particular to the housing 135 of torque converter 130. The radial portion 190 of the retaining element 185 may be dispensed with; usually, however, an axial and radial attachment of the retaining element 185 relative to the energy storage element 175 is required.

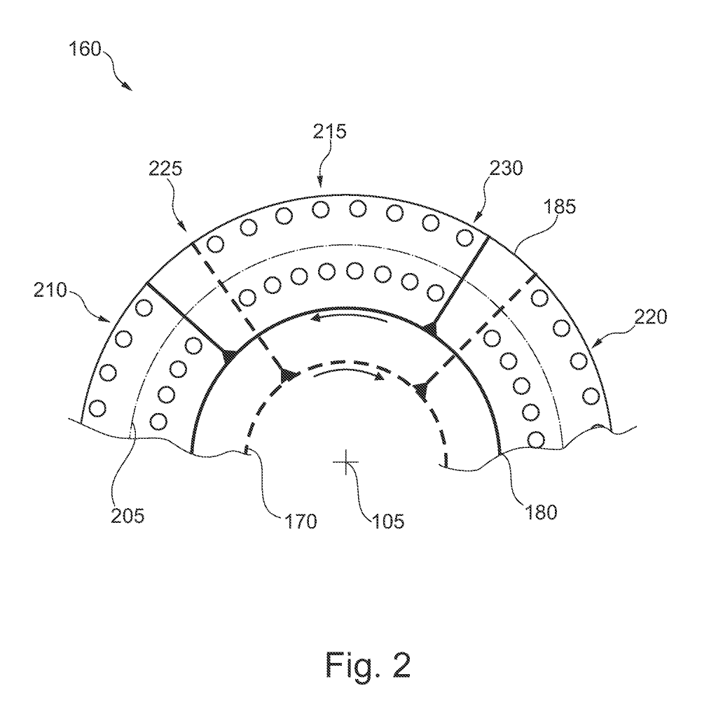

FIG. 2 is a diagrammatic illustration of the torsion damper 160 shown in FIG. 1 during a compression of the energy storage element 175. The torsion damper 160 is not limited to being used within torque converter 100; rather, the principle of the torsion damper 160 is usable for damping torsional vibrations during the transmission of a torque about an axis of rotation 105 in general.

Three energy storage elements 210, 215, and 220, each corresponding to the energy storage element 175 shown in FIG. 1, are distributed along a circumference 205 about the axis of rotation 105. At their radially outer sides, the energy storage elements 210 to 220 are held by the retaining element 185. Despite their geometrically serial arrangement, the energy storage elements 210 to 220 act in parallel between the input side 170 and the output side 180. The actuation of the energy storage elements 210 to 220 usually occurs in such a way that the energy storage elements 210 to 220 are compressed both in the case of a positive torsion angle and in the case of a negative torsion angle between the input side 170 and the output side 180.

The following description only refers to the uppermost energy storage element 215. Energy storage element 215 rests against a first axial end 225 on the input side 170 and against an opposite second end 230 on the output side 180 of the torsion damper 160. The windings of the energy storage element 215 are urged radially outward against the retaining element 185 as a result of centrifugal forces during a rotation of the energy storage element 215 about the axis of rotation 105 or as a result of shearing forces created by a compression of the energy storage element 215. Since the retaining element 185 runs freely relative to the input side 170 and to the output side 180, the windings of the energy storage element 215 located close to the ends 225 and 230 pass through portions of equal length of the retaining element 185 upon a compression or decompression of the energy storage element 215.

As a consequence, the compression or decompression of the energy storage element 215 may be damped less strongly and in particular more uniformly by the retaining element, a fact which may result in an improved responding behavior of the energy storage element 215.

Due to the fact that the ends 225, 230 respectively engage in the input side 170 and the output side 180, windings of the energy storage element 215 close to the ends 225, 230 may additionally be supported against a force that acts in a radially outward direction. Depending on their distance to the closest end 225, 230, windings of the energy storage element 215 located between ends 225 and 230 may be pressed against the retaining element 185 more strongly than windings close to the ends 225, 230, respectively. Thus, there may only be slight rotation of the retaining element 185 relative to the energy storage element 215 in the case of successive compressions and expansions of the energy storage element 215.

### Reference Numerals

100 torque converter
105 axis of rotation
110 primary side
115 output side
120 flange
125 hub
130 torque converter
135 housing
140 impeller
145 turbine
150 stator
155 fluid
160 torsion damper
165 friction clutch
170 input side
175 energy storage element
180 output side
185 retaining element
190 radial portion
195 shoulder
205 circumference
210, 215, 220 energy storage elements
225 first end
230 second end

What is claimed is:

1. A torsion damper, (160) comprising:
an input side (170) for introducing a torque;
an output side (180) for outputting a torque;
an energy storage element (175) arranged between the input side (170) and the output side (180) on a circumference (205) about an axis of rotation (105) to elastically transmit the torque between the input side (170) and the output side (180); and
a retaining element (185) arranged on a radially outer side of the energy storage element (175) to support the energy storage element (175),
wherein an angle of rotation of the retaining element (185) about the axis of rotation (105) relative to the input side (170) and relative to the output side (180) is not limited.

2. The torsion damper (160) recited in claim 1, wherein the retaining element (185) is designed to support the energy storage element (175) on one axial side.

3. The torsion damper (160) recited in claim 2, wherein the retaining element (185) is designed to support the energy storage element (175) also on the other axial side.

4. The torsion damper (160) recited in claim 1, wherein the retaining element (185) comprises a radial portion (190) as a radial support relative to the input side (170) or to the output side (180) to center the retaining element (185).

5. The torsion damper (160) recited in claim 4, wherein an axial fixing element (195) is provided on the input side (170) or on the output side (180) for fixing the radial portion (190) of the retaining element (185) in the axial direction.

6. The torsion damper (160) recited in claim 1, wherein the retaining element (185) is manufacturable from a sheet of material.

7. The torsional damper (160) recited in claim 1, wherein multiple energy storage elements (210, 215, 220) are provided that act in parallel and are supported by the retaining element (185).

8. The torsional damper (160) recited in claim 1, wherein the input side (170) or the output side (180) comprises a hub (125) that is connected in a torque-locking way to a radial element (170, 180) engaged with one end of the energy storage element (175).

9. A torque converter (100) including a torsion damper (160) recited in claim 1, wherein the torque converter (100) comprises a hydrodynamic transmission device (130) with a fluid (160) for transmitting a torque in parallel with the energy storage element (175).

10. The torque converter (100) recited in claim 9, wherein the retaining element (185) is exposed to the fluid (160) of the transmission device (130).
